(19) United States
(12) Patent Application Publication
(10) Pub. No.: US 2024/0198941 A1
(43) Pub. Date: Jun. 20, 2024

(54) VEHICLE WITH OCCUPANT TRAJECTORY-BASED AIRBAG SUPPRESSION

(71) Applicant: GM GLOBAL TECHNOLOGY OPERATIONS LLC, Detroit, MI (US)

(72) Inventors: Scott D. Thomas, Novi, MI (US); Dorel M. Sala, Troy, MI (US); Sean T. Coughlin, Shelby Township, MI (US); Praneeth Nelapati, Novi, MI (US); Lisa M. Furton, Beverly Hills, MI (US)

(73) Assignee: GM GLOBAL TECHNOLOGY OPERATIONS LLC, Detroit, MI (US)

(21) Appl. No.: 18/081,133

(22) Filed: Dec. 14, 2022

(51) Int. Cl. B60R 21/01; B60R 21/015; B60R 21/2338; B60R 21/239

(52) U.S. Cl. CPC B60R 21/01; B60R 21/01552; B60R 21/2338; B60R 21/239; B60R 2021/01211; B60R 2021/01286; B60R 2021/2395

(57) ABSTRACT

A method for controlling an airbag aboard a motor vehicle includes measuring a respective position of landmark points on an occupant of the motor vehicle using a sensor suite. The method includes receiving occupant landmark signals from the sensor suite, with the signals being indicative of the respective positions of the landmark points. A trajectory of the occupant is predicted, via the controller, using the occupant landmark signals. A controller adjusts a restraint capacity setting of the airbag in response to the predicted occupant trajectory. A motor vehicle includes a vehicle body, an airbag, a sensor suite, and a controller operable for controlling a restraint capacity setting of the airbag using the method. A non-transitory computer-readable storage medium includes an instruction set that is executed to perform the method.

### INTRODUCTION

In a passenger compartment or interior of a motor vehicle, vehicle seats are surrounded by or attached to one or more passenger restraint systems. For example, a modern vehicle interior is typically equipped with passenger restraint systems in the form of, e.g., lap-and-shoulder seatbelts, inflatable airbags, seatbelt pretensioners, adjustable head restraints, knee bolsters, energy-absorbing devices, etc.

With respect to airbags in particular, inflation of one or more airbags in the vehicle interior noted above is automatically triggered when onboard sensors detect a sudden threshold vehicle deceleration requiring airbag deployment. In response to measured forces or other characteristic values requiring such airbag deployment, the sensors transmit electronic signals to an airbag deployment control circuit. A typical airbag deployment circuit responds to the electronic signals by initiating a pyrotechnic process to generate and possibly release an inert inflation gas. The inflation gas is quickly released into an airbag cushion of the airbag, resulting in rapid inflation of the airbag cushion. The inflated airbag cushion then self-deflates to complete the airbag deployment process.

### SUMMARY

The control solutions described in detail below are collectively operable for regulating activation or deployment of an inflatable airbag aboard a motor vehicle based at least in part on an occupant's motion trajectory. As used herein for textual simplicity, “an airbag” means “at least one airbag” or “one or more airbags” unless otherwise specified. Those skilled in the art will appreciate that a given vehicle occupant may be restrained by multiple airbags in a modern vehicle interior, with the particular airbag(s) being deployed in response to a given airbag triggering event that itself may vary with the particular location of the occupant within the vehicle interior. Thus, the methodology described herein may be applied separately or collectively to each of the airbags used in the vehicle interior.

To help control airbag deployment within the scope of the present disclosure, interior sensors are outfitted to a given vehicle and configured to measure one or more parameters, e.g., occupant size, mass, position, etc. Airbag deployment decisions are made by an onboard controller based on these parameters, and in particular based on the changing position and resulting occupant trajectory or trajectories as set forth in detail below. One or more sensors may be used to detect and monitor changes in the occupant's location within the vehicle interior as part of the present solutions.

In particular, a method for controlling an airbag aboard a motor vehicle includes, in an exemplary embodiment, measuring, using a sensor suite of the motor vehicle, a respective position of one or more landmark points located on a body region of interest of an occupant of the motor vehicle, e.g., a point or points on an external surface of the occupant. The method according to this embodiment also includes receiving, via a controller, a set of occupant landmark signals from the sensor suite, as data points. The occupant landmark signals are indicative of, e.g., have a voltage or current level corresponding to, the respective position of the one or more landmark points. Additionally, the method includes determining, via the controller, a predicted trajectory of the occupant (“occupant trajectory”) using the occupant landmark signals, as well as automatically adjusting a restraint capacity setting of the airbag in response to the predicted occupant trajectory.

The method in one or more embodiments may include detecting at least one of a dynamic vehicle event, an oncoming object size, an oncoming object closing velocity, or an occupant movement event via the sensor suite. In response thereto, the method may include selectively adjusting a number of the landmark points used as data points during a sampling timeframe of interest, e.g., selectively repeating at least some of the data points during the sampling timeframe of interest to thereby increase a corresponding weight of the data points. The dynamic vehicle event may include a braking event of the motor vehicle, an avoidance maneuver event of the motor vehicle, an anticipated or imminent impact event of the motor vehicle, and/or an actual impact event of the motor vehicle in a possible implementation.

Selectively adjusting the number of the landmark points used as the sampled data points during the sampling timeframe of interest in response to the occupant movement event may occur in response to the occupant movement event, which in turn may include movement of a portion of one or more of a head, a neck, a torso, or a foot of the occupant within a predetermined distance of the airbag, e.g., within or predicted to be within an ASZ of the airbag.

Determining the predicted trajectory of the occupant may include extrapolating the predicted trajectory of the occupant from a time of a last sampling to at least one of a time of a potential contact by the occupant with the airbag, a time of a next sampling, or a point in time between the time of the potential occupant contact with the airbag and the time of the next sampling. Alternatively, determining the predicted trajectory could include using one or more mathematical curve fitting methods for the position of the occupant using a fixed window or a moving window, one or more predictive filtering techniques for signal processing, or artificial intelligence or machine learning methods.

The motor vehicle may include a seatbelt, in which case the method may include using a seatbelt usage status signal indicative of a usage of the seatbelt by the occupant to determine the location of an airbag suppression zone (ASZ) or adjust the restraint capacity setting of the airbag.

Receiving the occupant landmark signals, determining the predicted trajectory of the occupant, and automatically adjusting the restraint capacity setting of the airbag may be performed by the controller prior to and subsequent to an airbag deployment command decision of the controller. Additionally, determining the predicted trajectory of the occupant in one or more embodiments may include, subsequent to a deployment of the airbag in response to the deployment command decision, adjusting the restraint capacity setting when the predicted trajectory of the occupant will be within an ASZ when the occupant contacts the airbag.

At least one sensor of the sensor suite may have a field-of-view focus, in which case the method in some embodiments may include adjusting the field-of-view focus, via the controller, in response to at least one of the predicted trajectory, a dynamic vehicle event, an oncoming object, or an occupant movement event.

Automatically adjusting the restraint capacity setting may optionally include adjusting one or more of a deployment command decision of the controller, an inflator output, timing of an inflator output, a tether length of the airbag, an inflated cushion depth of the airbag, and a vent size of the airbag. The method may also include tracking a trajectory of a most forward point on the body region of interest of the occupant, with such a point predicted to be forward of an edge of an ASZ. Adjusting the restraint capacity setting in such an embodiment may include suppressing the airbag in response to the trajectory of the most forward point when the most forward point is a point on a head, a neck, a torso, or a leg of the occupant.

The motor vehicle may also include an instrument panel, in which case automatically adjusting the restraint capacity setting of the airbag may include suppressing the airbag when a leg of the occupant is placed on the instrument panel.

In one or more embodiments, the method may include determining a seated height of the occupant relative to the vehicle interior, automatically selecting at least one of the one or more landmark points, via the controller, based on the height of the occupant, as selected landmark points, and determining the predicted trajectory of the occupant using the selected landmark points.

Another aspect of the disclosure includes a motor vehicle having a vehicle body defining a vehicle interior, also referred to in the art as a passenger compartment. The motor vehicle includes an airbag positioned in the vehicle interior and having an ASZ, a sensor suite likewise positioned in the vehicle interior, and a controller. The sensor suite is configured to measure respective positions of one or more landmark points on a body region of interest of an occupant of the vehicle interior relative a position of the airbag. The controller in this representative implementation is operable for controlling a restraint capacity setting of the airbag, and for receiving occupant landmark signals from a sensor suite according to a sampling rate. Data points of the occupant landmark signals are indicative of respective locations of the one or more landmark points.

The controller is also programmed to determine a predicted occupant trajectory using the occupant landmark signals, and to automatically adjust a restraint capacity setting of the airbag in response to the predicted occupant trajectory. The landmark point(s) may include a landmark point located closest to the airbag relative to each of the one or more landmark points.

Also disclosed herein is a non-transitory, computer-readable storage medium on which is recorded an instruction set. Execution of the instruction set by a processor of a controller of a motor vehicle having an airbag causes the controller to receive occupant landmark signals from a sensor suite, with the occupant landmark signals being indicative of at least one landmark point on a body region of interest of the occupant, which in turn may be on an exterior surface of an occupant of the motor vehicle. Execution of the instruction set also causes the controller to determine a predicted occupant trajectory using the occupant landmark signals, and to automatically adjust a restraint capacity setting of the airbag in response to the predicted occupant trajectory.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 schematically illustrates a representative motor vehicle having a vehicle interior equipped with one or more airbags, the respective restraint capacity settings of which are adjusted by a controller based at least in part on predicted trajectories of an occupant's body or regions of interest thereof or thereon.

FIG. 2A is a simplified side view illustration of a belted occupant in a typical upright seating position.

FIG. 2B is a side view illustration of the occupant shown in FIG. 2A illustrating possible locations of a belted and unbelted occupant's body during a dynamic vehicle event relative to an exemplary airbag location.

FIG. 3 is a schematic circuit illustration of the occupant, associated passenger restraint systems, and a controller operable for selectively modifying restraint capacity settings of airbags and possibly other passenger restraints using a trajectory-based control strategy as set forth herein.

FIG. 4 illustrates a head of the occupant depicted in FIGS. 1-3, with the head depicted with multiple occupant landmark locations or points (“landmarks”) in accordance with an aspect of the disclosure.

FIG. 5 illustrates sampling adjustments that could be selectively implemented in accordance with one or more embodiments of the disclosure.

FIG. 6 is a plot of a representative landmark trajectory versus an event time illustrating an aspect of the present disclosure.

FIG. 7 is a plot of longitudinal acceleration of the motor vehicle shown in FIG. 1 versus event time illustrating another aspect of the present disclosure.

FIG. 8 is a flow chart describing an exemplary embodiment of a method for dynamically adjusting restraint capacity settings of airbags and possibly additional passenger restraint systems in accordance with the disclosure.

FIG. 9 is a representative plot describing an optional increase in data point weight based on vehicle deceleration.

The appended drawings are not necessarily to scale, and may present a simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments may be arranged in a variety of configurations. Thus, the following detailed description is not intended to limit the scope of the disclosure as claimed, but is merely representative of possible embodiments thereof. In addition, while numerous specific details are set forth in the following description to provide a thorough understanding of various representative embodiments, some embodiments may be capable of being practiced without some of the disclosed details. Moreover, in order to improve clarity, certain technical material understood in the related art has not been described in detail. Furthermore, the disclosure as illustrated and described herein may be practiced in the absence of an element that is not specifically disclosed herein.

Associated restraint activation logic of an electronic control unit or “controller” as contemplated herein is determined and adjusted in real-time based on one or more predicted trajectories of different body regions of a passenger or occupant of a motor vehicle. Occupant trajectory predictions as described in detail below may include monitoring and measuring designated occupant landmark locations or points (“landmarks”) on a body region of interest of the occupant's body, and estimating where such landmarks will be in the immediate future. The predicted occupant trajectories are used as input conditions for restraint activation logic of the aforementioned controller, with the controller ultimately determining an actual restraint capacity setting of the airbag and possibly other passenger restraints. With respect to control decisions for inflation of the airbags, the inflation of associated airbag cushions is selectively enabled, suppressed, or disabled as a result of executing the disclosed restraint activation logic. In addition, airbag cushion parameters such as the quantity of inflator provided gas, cushion shape, and cushion venting can also be tailored. Other non-airbag restraints may also have their respective restraint capacities modified based on the predicted occupant trajectories within the scope of the disclosure.

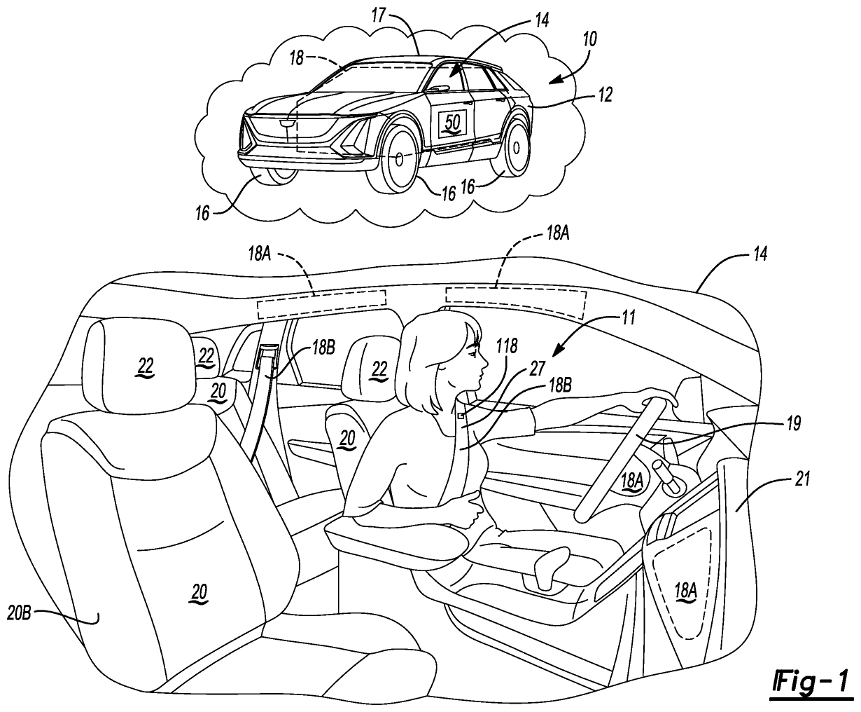

Referring now to the drawings, wherein like reference numbers refer to like features throughout the several views, FIG. 1 depicts a mobile system in the non-limiting representative form of a motor vehicle 10. The motor vehicle 10 includes a vehicle body 12 defining a vehicle interior 14 and road wheels 16 connected thereto. While the motor vehicle 10 is described hereinbelow as a passenger vehicle for illustrative consistency, those skilled in the art will recognize that the present teachings may be applied to other mobile systems using one or more of the passenger restraint systems 18 and a controller 50 in communication therewith, as described in detail below.

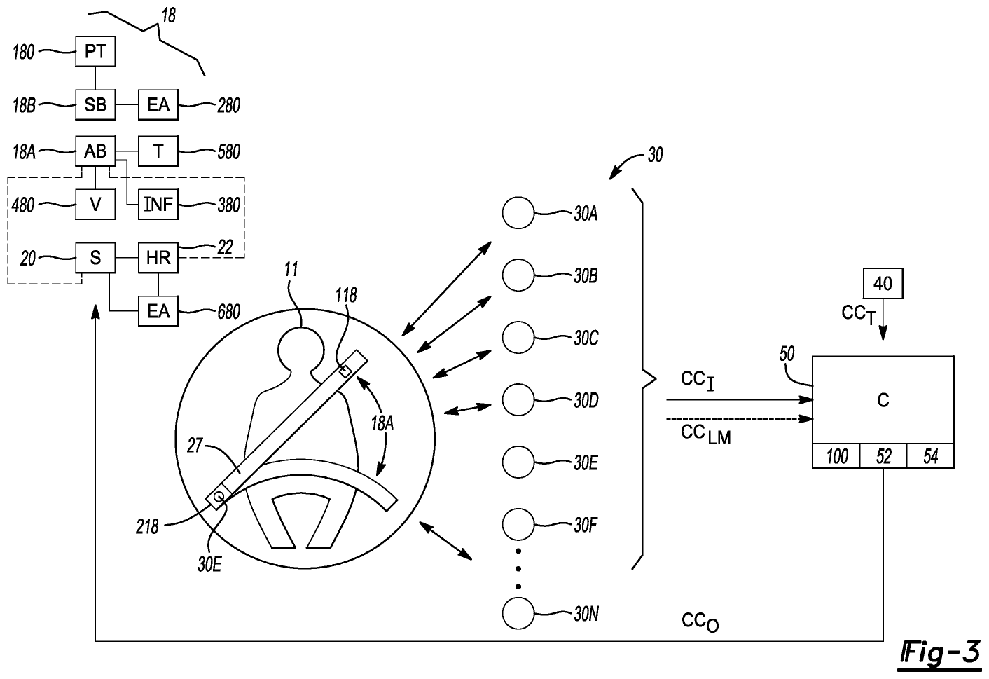

The passenger restraint systems 18 may include one or more inflatable airbags 18A, which are referred to hereinafter in the singular (“an airbag 18A”, “the airbag 18A”, etc.) solely for illustrative and descriptive simplicity, and without limiting the actual number of airbags 18A used in a given construction of the vehicle interior 14, or the location of these airbags 18A within the vehicle interior 14. The passenger restraint systems 18 may also include additional restraint devices, including but not necessarily limited to seatbelts 18B, vehicle seats 20, head restraints 22, and one or more of the various devices described below with reference to FIG. 3.

Within the scope of the present disclosure, the controller 50 shown schematically in FIG. 1 is configured to execute a computer-readable/executable instruction set embodying a method 100, a non-limiting example embodiment of which is described below with reference to FIG. 8. By executing the constituent steps or logic blocks of the method 100, the controller 50 is able to selectively adjust a respective restraint capacity setting of each of the passenger restraint systems 18. The controller 50 performs such actions based at least in part on a position of the occupant 11 and one or more trajectories of the occupant 11 (“occupant trajectories”) within the vehicle interior 14.

In particular, the controller 50 as contemplated herein is programmed or otherwise configured to predict individual trajectories of one or more different body regions of interest of the occupant 11. This occurs using measured occupant landmark locations or points, e.g., on external surfaces of the occupant 11, with such points referred to herein as “landmarks” for simplicity. In doing so, the controller 50 may employ mathematical methods and/or application-suitable data filtering techniques to predict a next point of each landmark on a straight or curved trajectory line. The predicted occupant trajectories are used by the controller 50 to selectively suppress or enable the airbag 18A as needed based on the present and impending proximity of the occupant 11 to the airbag 18A. The occupant trajectories may also be used to modify airbag restraint capacity/capacities by controlling the quantity of inflator gas, the airbag cushion shape, and/or airbag cushion venting. In addition, the present monitoring and control strategy may include modifying the restraint capacity of the seatbelts 18B and the vehicle seats 20 in one or more implementations. In performing its programmed functions, the controller 50 may continue to monitor actual or predicted movements of the occupant 11 after sampling, prior to, and possibly subsequent to deployment of the airbag 18A.

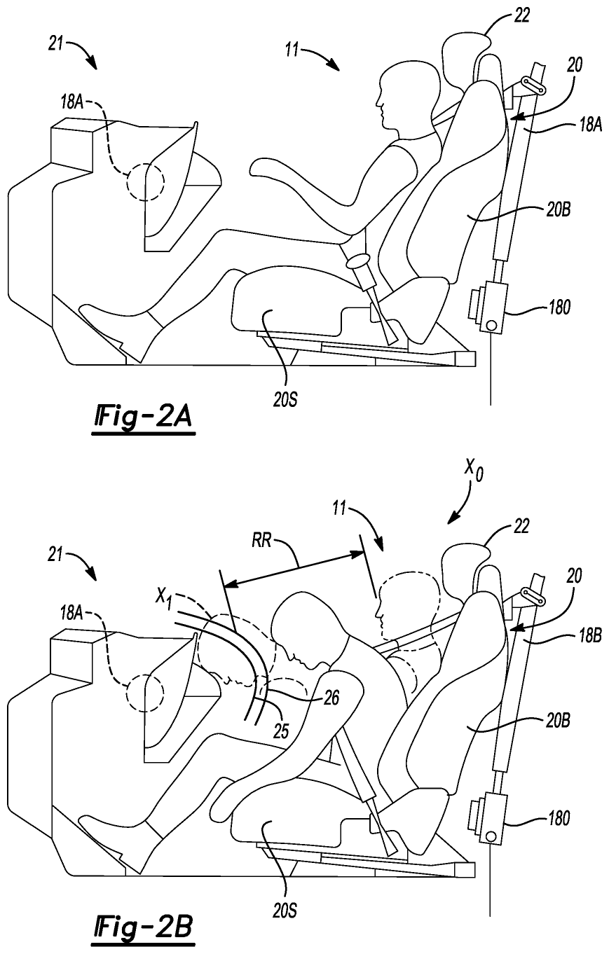

The representative vehicle interior 14 depicted in FIG. 1 includes moveable or adjustable embodiments of the aforementioned vehicle seats 20. Solely for illustrative clarity and simplicity, a single occupant 11 is depicted in FIG. 1, with the occupant 11 acting as a driver of the motor vehicle 10. However, the present teachings are extendable to additional occupants 11 possibly seated elsewhere within the vehicle interior 14, including front or rear occupants 11. As an example, FIGS. 2A and 2B illustrate a front occupant 11. Each vehicle seat 20 may be equipped with an adjustable head restraint 22, with the vehicle seats 20 and the head restraints 22 possibly having a respective adjustable position, angle, energy absorption setting, and/or other restraint capacity setting. The vehicle seats 20 and the head restraints 22 are therefore included among the passenger restraint systems 18 in one or more implementations of the present teachings. The vehicle seats 20 and the head restraints 22 could be manually moveable, motorized, or otherwise configured to move when deployment is commanded or triggered, for instance via a released spring, motor, or a pyrotechnic device as appreciated in the art.

Referring briefly to FIG. 3, the head restraints (“HR”) 22 and the vehicle seats (“S”) 20 may be equipped with adjustable devices such as an energy absorbing device (“EA”) 680 or airbags (“AB”) 18A. The seatbelts (“SB”) 18B may be equipped with adjustable devices such as a motorized or pyrotechnic pretensioner (“PT”) 180 and an energy-absorbing device (“EA”) 280. The airbags 18A may be equipped with an inflator device (“INF”) 380, one or more airbag vents (“V”) 480, and one or more airbag tethers (“T”) 580. The collective set of passenger restraint systems 18, the combination of which may vary with the construction of the motor vehicle 10 of FIG. 1, is used in one or more embodiments in conjunction with the airbag (“AB”) 18A.

Referring once again to FIG. 1, as appreciated by those skilled in the art, a pyrotechnically-deployable, inflatable airbag system such as the representative airbag(s) 18A of FIG. 1 are available in a variety of forms. For example, the airbag 18A could be situated in or near an instrument panel 21, packaged within a steering wheel 19, in a panel adjacent thereto, along/below the instrument panel 21, along sides of the vehicle interior 14, in a roof 17 of the motor vehicle 10, in several locations within the vehicle seats 20, e.g., under a seat bottom cushion on the inboard side of a seat back 20B, on the outboard side of the seat back 20B, in the back of the seat back 20B, in the head restraint 22, and possibly within seatbelt webbing 27 of the seatbelts 18B. The vehicle interior 14 could therefore be equipped with a model-specific combination frontal airbags, curtain airbags, knee airbags, seatbelt airbags, overhead airbags, under-thigh airbags, side impact airbags, and/or other airbags 18A within the scope of the disclosure. Such airbags 18A are rapidly inflated, e.g., about fifty milliseconds (50 ms) or less, with inflation typically occurring in response to a chemical charge that creates an inflation gas, releases a stored inflation gas, or as a combination of both to allow each airbag 18A to quickly deploy and expand.

Referring to FIG. 2A, the controller 50 is operable for assessing a current position and a changing position of the occupant 11 within the vehicle interior 14 of FIG. 1. FIG. 2A corresponds to a typical upright seating position of the occupant 11 in a non-limiting example scenario in which the occupant 11 faces the instrument panel 21. Other embodiments may be envisioned in which the occupant 11 could be in a different position, posture, or location, and possibly proximate a differently situated airbag 18A. The occupant 11 when seated on a seat cushion 20S is typically resting against a back cushion 20B of the vehicle seat 20, with the occupant 11 positioned adjacent to the head restraint 22. Depicted as a belted occupant, the occupant 11 of FIG. 1 is shown wearing the seatbelt 18A, with the pretensioner 180 also shown in FIG. 2A. In alternative embodiments (not shown), the pretensioner 180 could be located at the end of a seatbelt buckle of the seatbelt 18B or an outboard lower anchor of the seatbelt webbing 27.

As illustrated in FIG. 2B, during a predetermined dynamic event such as a hard braking event, an aggressive obstacle/object avoidance maneuver, an impact event, etc., the occupant 11, when properly wearing the seatbelt 18B, will be moved closer to the airbag 18A to a non-limiting position such as the representative position x₁. That is, the occupant 11 starting at a representative initial position x₀ corresponding to the upright seating position of FIG. 2A will tend to move a distance RR toward the airbag 18A. The non-limiting forward position x₁ may also be reached during an in-vehicle/occupant movement event during which the occupant 11 moves a portion of their body forward, such as when leaning forward to access an object located on the floor or stowed in a glovebox of the instrument panel 21.

In contrast to the representative position x₀, the occupant 11 when unbelted could possibly reach a forward position that is closer to the instrument panel 21 and similar to the position x₁ during the dynamic vehicle event or the in-vehicle/occupant movement event, e.g., when a portion of one or more of a head, neck, torso, or foot of the occupant 11 is within a predetermined distance of the airbag 18A. Relative to the depicted position x₀, the representative position x₁ is closer to the airbag 18A in this exemplary deployment scenario.

Also shown in FIG. 2B is a representative first airbag suppression zone (ASZ) having a first ASZ edge 25. The first ASZ edge 25 represents an outer limit of a space between the airbag 18A (when inflated) and the occupant 11. Within this space, i.e., if the occupant 11 were to be situated forward of the first ASZ edge 25 during a deployment of the airbag 18A, the occupant 11 might experience excessive loading by the deploying airbag 18A. The first ASZ in some configurations may be used for unbelted occupants 11, while in other configurations the first ASZ may be used for seated occupants 11 regardless of their belted/unbelted status. In this manner the controller 50 is able to suppress or otherwise modify the restraint capacity setting(s) of the airbag 18A in the event that the occupant 11 intrudes into the space located forward of the first ASZ edge 25.

A representative second airbag suppression zone (ASZ) is also shown in FIG. 2B having a second ASZ edge 26. The second ASZ edge 26 is located closer to the occupant 11 when in the representative initial position x₀. Similar to the first ASZ edge 25, the second ASZ edge 26 represents a limit of space between the airbag 18A and the occupant 11. The second ASZ in one or more implementations may be used for belted and seated occupants 11 to suppress or otherwise modify the restraint capacity setting of the airbag 18A in the event the occupant 11 intrudes into the space located forward of the second ASZ edge 26.

In an optional approach, the controller 50 may monitor the position of the occupant 11, likely when the occupant 11 is wearing the seatbelt 18B, prior to a dynamic vehicle event. Exemplary dynamic vehicle events include, by way of example and not of limitation, a braking event of the motor vehicle 10, an avoidance maneuver event of the motor vehicle 10 such as aggressive steering action to avoid an obstacle in the path of the motor vehicle 10, an anticipated or imminent impact event of the motor vehicle 10, or an actual impact event of the motor vehicle 10, and/or in-vehicle/occupant movement event. The controller 50 may then determine if the airbag 18A is to be suppressed based on a position of the occupant 11 prior to the event, as at such a time, the occupant 11 could be in many possible locations. This action would eliminate the need to perform a dynamic occupant position assessment during the event. The second ASZ in this particular case would be located farther from the airbag 18A than is the first ASZ, so that the amount of motion from the belted occupant 11 during the event would not cause the occupant 11 to intrude into the first ASZ as demarcated by the edge 25. In an alternative approach, perhaps less likely to implement but nevertheless viable in certain constructions of the motor vehicle 10, the edge 26 of the second ASZ may be located closer to the airbag 18A than is the edge 25, i.e., the distance between the edge 26 and the airbag 18A could be smaller than the distance between the edge 25 and the airbag 18A.

As depicted in FIG. 2B, predicted occupant trajectories of a belted and unbelted occupant 11 may significantly deviate. That is, the seatbelt 18B will restrain forward motion of the occupant 11 (as shown by the solid outlined occupant 11), with this motion possibly not restrained for unbelted occupants 11 (as shown by the dashed outlined occupant at position x₁) unless the occupant 11 significantly braces against the instrument panel 21 to reduce forward motion.

For higher impact severity events, the present approach in one or more optional embodiments may include detecting an impact severity and/or an oncoming object closing velocity or speed relative to the motor vehicle 10 of FIG. 1. In response, the controller 50 may temporarily establish an unsuppressed restraint state of the airbag 18A or a higher restraint state of the airbag 18A based at least in part on the impact severity, the object closing velocity or speed, the object size, or a combination of these factors, in addition to the predicted occupant trajectories. Usage of this approach may be limited to occupants 11 who have been detected as unbelted occupants 11, to occupants 11 who have been detected as being belted occupants 11, or the approach could be applied in the same manner to both unbelted and belted occupants 11 alike.

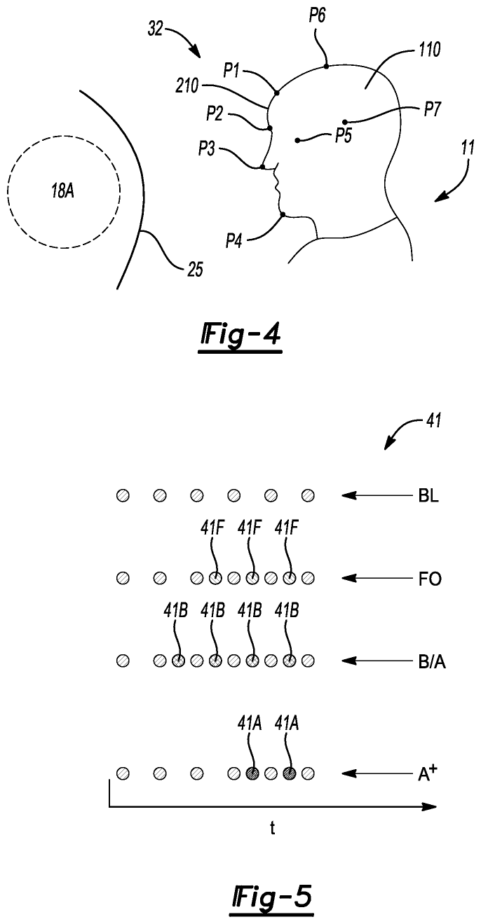

Occupant trajectory prediction and the consideration of such predicted occupant trajectories in subsequent airbag restraint deployment decisions of the controller 50 are explained for simplicity and clarity with respect to a non-limiting example of FIG. 4. As part of the present strategy, the controller 50 of FIG. 3 may receive occupant landmark signals (arrow CC_{LM}) from an onboard sensor suite 30 according to a calibrated sampling rate, e.g., every 10-1000 ms or another application suitable nominal rate. The landmark signals (arrow CC_{LM}) are collectively indicative of a current position of at least a portion of a body region of interest of the occupant 11 relative to the position or location of the airbag 18A.

In the simplified representative case of a head 110 of the occupant 11 as depicted in FIG. 4, one or more landmarks 32 may be assigned to the head 110, with the landmarks 32 being different positions, in this case on the external surfaces 210. The present approach may optionally include measuring a seated height of the occupant 11 relative to the vehicle interior 14 via the sensor suite 30 of FIG. 3. The approach may continue by automatically selecting or adjusting which one or more of the landmarks 32 to use for occupant trajectory prediction. Alternatively, the controller 50 may identify the outline or “outer shell” of the occupant 11 and use such an outline or outer shell (or an overlayed skeleton) to identify suitable landmark locations.

In the non-limiting exemplary embodiment of FIG. 4, the landmarks 32 include a point P1 located on the forehead of the occupant 11, a point P2 located between the eyes of the occupant 11, and a point P3 located on a tip of the occupant's nose. Other landmarks 32 whose trajectories may be tracked as part of the present strategy could include a point P4 on a chin of the occupant 11, one or more points P5 on a cheekbone or other prominent location of the occupant's face, such as the eyes (not shown), a point P6 on the top or crown of the head 110, and/or respective points P7 (one of which is visible in FIG. 4) on the ears of the occupant 11. Thus, relative to the first ASZ edge 25 (or the second ASZ edge 26 of FIG. 2B) and the airbag 18A, the landmarks 32 each have different separation distances and, with the three-dimensional motion of the occupant 11, different resulting trajectories.

The landmarks 32 located on other body regions of interest of or on the occupant 11, such as shoulders, arms, legs, feet, etc., may be similarly designated and tracked in real time within the scope of the present disclosure, as noted above and as appreciated in the art. Likewise, additional landmarks 32 may be used on the head 110 or other body regions of interest. In addition, the most forward point of the external surface of the occupant 11 could be used for each body region of interest, regardless of the specific location on that specific region. The occupant trajectory may be calculated in some embodiments using a particular landmark point 32 having, relative to each of the one or more landmark points 32, a shortest distance to the airbag 18A, i.e., closest to the airbag 18A relative to the remaining landmark points 32.

Referring again to FIG. 3, each of the airbags 18A used within the vehicle interior 14 of FIG. 1 may include the above-noted inflator 380, airbag vents 480, airbag tethers 580, or combinations thereof in these different configurations. The inflator(s) 380 may include an elongated body or a “squat” body, e.g., containing one or more selectively activated or stored gas propellant charges. In multi-stage embodiments of the airbag 18A in particular, two or more such inflators 380 may be connected to the airbag 18A, with each inflator 380 in turn having a corresponding inflation capacity setting. The inflators 380 are typically within the same inflator body and may share components. The inflators 380 in some embodiments may be staged or sequenced to deploy at different times or within an adjustable interval of each other, or one of the inflators 380 may activate and not the other.

The airbag vents 480 of FIG. 3 for their part may open to a greater degree to present a softer airbag 18A to the occupant 11 during deployment, or to a lesser degree to provide a harder surface of the airbag 18A. The airbag vents 480 may be embodied as discrete vents or the sizes of the vents 480 may be controlled by the airbag tethers 580 in the airbag 18A, or by a pyrotechnic device (not shown). The airbag tethers 580, which for their part control the inflated shape of the airbag 18A as appreciated in the art, may be fixed length tethers or tethers that extend or release when a pyrotechnic device is deployed. Restraint capacity settings are thus controllable by adjusting the inflator output, the vent output, and/or the tether length. Additionally, a restraint capacity setting of one or more of the vehicle seats 20 or seat-based devices may be controlled as part of the present strategy, including moveable portions of the vehicle seats 20, the head restraints 22, and associated energy absorption devices 680, along with the seatbelt pretensioners 180, the seatbelt energy-absorbing devices 280, etc., as shown schematically in FIG. 3.

In a possible approach, the controller 50 of FIG. 3 may assess the landmarks 32 (FIG. 4) of the occupant 11 based on defined criteria referred to herein as “occupant classes”. When an occupant 11 enters the vehicle interior 14, for example, the controller 50 could examine the occupant 11 for certain identifiable attributes or combinations thereof, e.g., the occupant's weight, size, seated height, shape, etc., and then compare these attributes to calibrated or predetermined threshold values.

In this manner, the controller 50 could measure a range of occupant classes using the sensor suite 30 and automatically adjust restraint capacity settings of the airbag 18A based on predicted occupant trajectories and this additional criteria. Such an action may entail establishing an unsuppressed state or a higher restraint capacity condition when the occupant class of the measured range is above a predetermined threshold or when the occupant 11 is verified as being within or matching a predetermined occupant class. Likewise, this action may entail establishing a suppressed state or a reduced restraint capacity state when the occupant class is below a predetermined threshold or when the occupant 11 is verified by the controller 50 as being within or matching a predetermined occupant class.

As appreciated by those skilled in the art, one or more sensors 40 of a typical sensing and airbag deployment system are configured to monitor or measure a host of variables, including but not necessarily limited to external impacts, wheel speeds, lateral and longitudinal accelerations, occupant presence status in a seating region, occupant position, object/animal presence in a seating region, object/animal position, seatbelt usage, brake pressure, steering angle, pitch, yaw, roll, etc., some of which may also be detected or may be separately detected by one or more sensors of the sensor suite 30 shown in FIG. 2. The sensors 40 relay electronic input signals to the controller 50 as restraint triggering signals (arrow CC_{T}). The controller 50 analyzes the triggering signals (arrow CC_{T}) and thereafter orchestrates onboard functions of the passenger restraint system(s) 18, e.g., by locking the seatbelts 18B, controlling the seatbelt pretensioners 180 and energy absorption 280, inflating one or more airbags 18A, controlling the venting of one or more of the airbags 18A, controlling the length of the airbag tether(s) 580 of one or more of the airbags 18A, controlling latching/unlatching states of door locks (not shown), positioning the head restraints 22 or seats 20, controlling seat energy absorption 680, etc. The controller 50 is therefore made aware of multiple sensor readings from the sensors 40 and the sensor suite 30 while the motor vehicle 10 of FIG. 1 is in operation.

With respect to the sensor suite 30 shown schematically in FIG. 3, representative sensor devices may include, without limitation, at least one in-seat sensor 30A such as a pressure-detecting bladder, a resistance-detecting surface that changes state when the surface is compressed, a load cell system, and/or a capacitive sensor. As used herein, “in-seat” refers to integration with a corresponding one of the vehicle seats 20 of FIG. 1, for instance embedded within the vehicle seats 20 and/or connected thereto.

The onboard sensor suite 30 may also include one or more remote sensors 30B, i.e., “remote” with respect to the occupants(s) 11 and the vehicle seats 20. Such remote sensors 30B may be situated within the vehicle interior 14 of FIG. 1, for instance attached to a rearview mirror (not shown), mounted to the inside vehicle roof structure (not shown), mounted to a pillar structure (not shown), or mounted to the instrument panel 21. In various possible embodiments, the remote sensors 30B could include radar, lidar, ultrasound sensors, a camera, e.g., red-green-blue (RGB), RGB+infrared (IR), IR, time-of-flight (TOF), structured light, thermal, stereo vision, etc.

Other possible sensors of the representative sensor suite 30 of FIG. 3 include biometric sensors 30C, which could be mounted to the vehicle interior 14 and/or worn by the occupant 11. Exemplary biometric data that could be measured and reported by the biometric sensors (“biosensors”) 30C include a heartbeat or respiration rate of the occupant 11 or micromotions thereof, a voice, body temperature, brain waves, fingerprints, alcohol level, the presence of implanted medical devices such as pacemakers, other metal content inside the body, heat, muscle activation, etc. Such measurements may be used in one or more embodiments to further control associated ASZs of the airbag 18A or the restraint capacity of the airbag 18A.

The collective set of information provide to the controller 50 by the onboard sensor suite 30 of FIG. 3 also includes occupant position data from one or more occupant position sensors 30D, e.g., additional cameras, remote sensors, or proximity detectors operable for determining a position of the occupant 11 within the vehicle interior 14 of FIG. 1. As the various landmarks 32 exemplified in FIG. 4 are monitored and tracked in real time, the occupant position sensors 30D may be collectively configured to generate a three-dimensional point cloud of the occupant 11, or at least the relevant anatomy, external surface shells, skeleton overlays, joint locations, or body regions thereof, as appreciated in the art. Example hardware for such a purpose includes multiple LIDAR sensors or laser profile sensors, ultrasound sensors, radar, time-of-flight (TOF), structured light, thermal, stereo vision, etc., with these and other possible constructions being usable in different implementations of the present teachings.

As noted below, collected data could be combined with data from the various other sensors 30A, 30B, 30C, 30D, and possibly one or more other sensors as represented by 30N, to “fine tune” the predictive accuracy of the controller 50 when predicting trajectories of the landmarks 32 and thereafter controlling the occupant restraint system(s) 18. The other sensors 30N could include a buckle switch 30E and possibly a seatbelt routing sensor 30F, the latter of which detects the presence of the identifiable characteristic 118 of the seatbelt 18A or the seatbelt webbing 27 in front of the occupant's torso and associates the identifiable characteristic 118 or absence thereof with a belted or unbelted occupant 11, respectively. The presence and use of other sensors not specifically mentioned herein is possible in other configurations. Note that some of the sensors 30A, . . . , 30N may detect more than one of the desired detection functions described herein.

With respect to the identifiable characteristics 118, in one or more embodiments the identifiable characteristics 118 may include a color and/or sheen of the seatbelt webbing 27 of the seatbelts 18B, specific identifiable patterns on the seatbelt webbing 27 such as stripes, checks, and/or other discrete markings. The identifiable characteristics 118 may include an embedded detectable element such as a magnet, a piece of metal, or another item that is detectable by the remote sensor 30B. Materials that reflect or block certain light wavelengths may be added as a coating on the webbing or on/within the threads within the seatbelt webbing 27, for instance infrared (IR)-absorbing and reflecting materials.

When an identifiable characteristic 118 is used to detect a presence of the seatbelt 18B, the seatbelt 18B may be deemed to be present/used by the occupant 11 when the shoulder belt present on the occupant's torso is detected, and not present/not used when the shoulder belt is not detected on the occupant's torso. Detection of the lap belt may not be part of the seatbelt usage determination logic in some embodiments, because the lap belt could be out of the field-of-view of relevant sensors of the sensor suite 30 or obscured by the occupant's body or objects on the occupant's lap. However, the present method in other implementations may include lap belt detection.

A seatbelt presence detection signal may also be generated by the remote sensor 30B indicative of a seatbelt usage status. Thus, occupant trajectory prediction and tracking may be evaluated by the controller 50 in conjunction with seatbelt usage and the presence and position of the occupant 11 relative to a defined limit or edge of the ASZ, possibly in conjunction with one or more other conditions as described below. The controller 50 may thereafter selectively adjust a location of one or more ASZs as a control action in response to the various data.

In accordance with the present disclosure, the controller 50 executes computer-readable instructions embodying the method 100 in response to electronic input signals (arrow CC_{I}) to perform the various functions described herein, with the electronic input signals (arrow CC_{I}) including the above described occupant landmark signals (arrow CC_{LM}) of FIG. 3. The term “controller” and related terms such as microcontroller, electronic control unit, etc., refer to one or various combinations of Application Specific Integrated Circuit(s) (ASIC), Field-Programmable Gate Array (FPGA), electronic circuit(s), central processing unit(s), e.g., microprocessor(s) and associated transitory and non-transitory memory/storage component(s).

The controller 50 of FIGS. 1 and 3 is depicted schematically as having a processor 52 of one or more of such types, as well as memory 54 inclusive of tangible, non-transitory computer storage medium/media (read only, programmable read only, solid-state, random access, optical, magnetic, etc.). The memory 54, on which computer-readable instructions embodying the method 100 may be recorded, is configured to store a machine-readable instruction set in the form of one or more software or firmware programs or routines, combinational logic circuit(s), input/output circuit(s) and devices, signal conditioning and buffer circuitry and other components that can be accessed by one or more processors to provide a described functionality.

Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Ultimately, the controller 50 outputs control signals (arrow CC_{O}) to one or more of the passenger restraint systems 18 described herein to regulate an actual restraint capacity setting thereof.

Referring now to FIG. 5, representative trajectories are shown for landmarks 32 throughout time as the landmarks 32 move in a forward direction toward the airbag 18A. The tracking of landmarks 32, some of which are exemplified in FIG. 4, when predicting occupant trajectories as set forth herein requires collection of data samples 41 from the various sensors of the sensor suite 30 of FIG. 3. The number of such data samples 41 for a given location of the occupant 11 within the vehicle interior 14 of FIG. 1 may be selectively increased if the controller 50 detects that a threshold deceleration, force, or impact event is imminent, is occurring, or if the occupant 11 is located close to the airbag 18A whose restraint capacity settings are ultimately being controlled. The controller 50 may optionally track one or more selected landmarks 32 on a body region of interest of the occupant 11 using logic for treating head/neck/torso landmarks 32 differently than, e.g., landmarks 32 located on external surfaces of arms and/or legs/feet of the same occupant 11. Treatment may also differ based on factors such as the seated height of the occupant 11. Additionally, the location of one or more ASZs or edges thereof may be automatically adjusted by the controller 50 based on the occupant trajectories and other relevant factors, e.g., experienced vehicle deceleration and seatbelt usage.

Within the scope of the disclosure, the controller 50 of FIGS. 1 and 3 may adjust its sampling rate in response to different sampling rate criteria. For example, the controller 50 may start with a baseline (“BL”) sampling rate for use in normal driving conditions. In a forward occupant scenario (“FO”), i.e., when the electronic input signals (arrow CC_{I}) indicate that the occupant 11 has moved forward in the vehicle interior 14 of FIG. 1, such as toward the respective first and second ASZ edges 25 and 26 of FIG. 2B or toward another of the various airbags 18A arranged in the vehicle interior 14, the controller 50 may increase the sampling rate by a suitable amount, e.g., at least doubling a sampling rate of an immediately prior measurement. This action entails adding additional data samples 41F to the baseline rate. Conditions such as braking levels or higher acceleration (“B/A”) may result in the controller 50 adding additional data samples 41B, with additional samples 41A likewise being added in response to detected high levels of acceleration (“A+”).

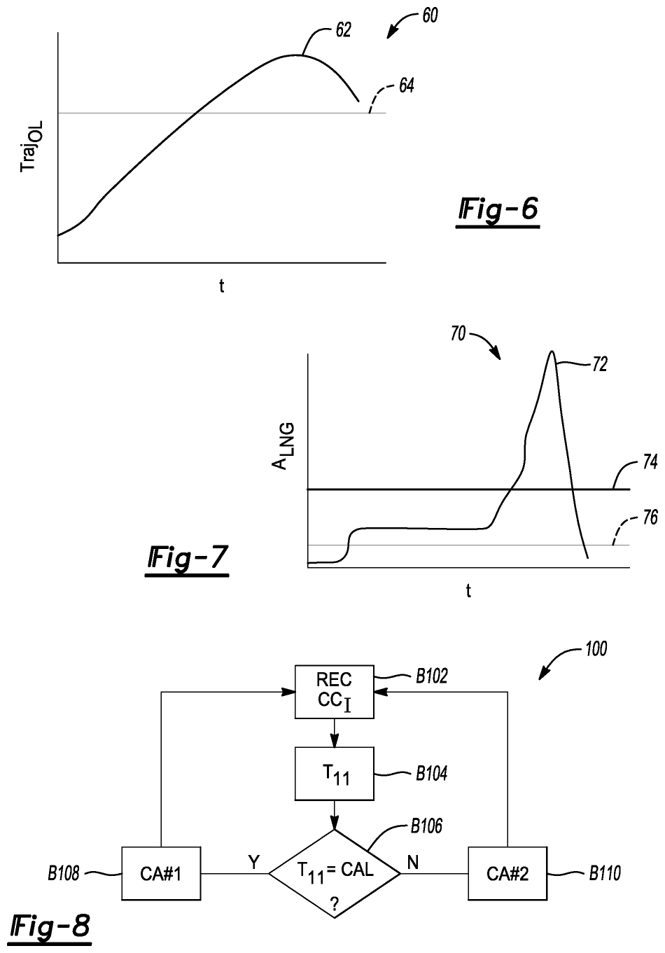

As shown in FIGS. 6 and 7, the decision of the controller 50 when regarding when and how to adjust the sampling rate may be informed by occupant location and vehicle acceleration, respectively. For instance, plot 60 of FIG. 6 illustrates a representative occupant landmark trajectory (Traj_{OL}), i.e., trace 62, versus time (t), with time being an event time or duration of a braking event or an actual or anticipated impact event of the motor vehicle 10. An application-suitable threshold 64 may be recorded in logic of the controller 50, with adjustments to the sampling rate being triggered when the occupant landmark trajectory 62 is above the threshold 64. Similarly, plot 70 of FIG. 7 illustrates a trace 72 of longitudinal acceleration (A_{LNG}) of the motor vehicle 10 versus the same event time (t) of FIG. 6, with different thresholds 74 and 76 being applied for higher acceleration and braking levels (with a lower acceleration), respectively. The sampling rates of FIG. 5 thus changes in response to threshold comparisons shown in FIGS. 6 and 7.

Other approaches may be used to increase the data point weight or sampling rate, such as the detection of an oncoming object that is likely to contact the motor vehicle 10, either based on a detected object size, closing velocity or speed, or a combination of such factors. In addition, the amount of lateral movement or angular movement of the motor vehicle 10 could be used in one or more embodiments as a trigger for increasing the data point weight and/or sampling rate, as higher levels of these measurements may occur in an avoidance maneuver event.

During a vehicle event that triggers deployment of the airbag 18A, vehicle deceleration increases above a calibratable “panic braking” magnitude. This increased deceleration can cause the occupant 11 to move forward relative to the vehicle 10 in a quicker manner relative to normal braking. The present strategy may be modified to increase the corresponding weights of the data points occurring during events that result in increased vehicle deceleration. Since existing data points alone can be used, the data points collected during periods of higher deceleration may be repeated to provide such data points with additional weight, e.g., by using double or triple data points for a given data sample.

Mathematical curve fitting techniques using the data points from a moving window of time could have extra data points during the timeframe corresponding to the higher deceleration event. The higher deceleration rate may be identified based on the vehicle acceleration level. The number of extra data points during a higher deceleration event may be associated with the vehicle deceleration level to add additional data points when deceleration levels are higher. A lookup table could be used for this purpose in one or more embodiments, e.g., a lookup table indexed by deceleration level and the number of data points. For instance, a deceleration level (D) of less than or equal to about 1.5 g could be treated with one data point, while a deceleration level of between about 1.5 g and about 3.0 g could be treated with two data points, and a deceleration level of about 3.0 g or more could be treated with three data points. Acceleration level boundaries may be varied as a calibratable input or hard-coded into the particular algorithm(s) embodying the present method 100.

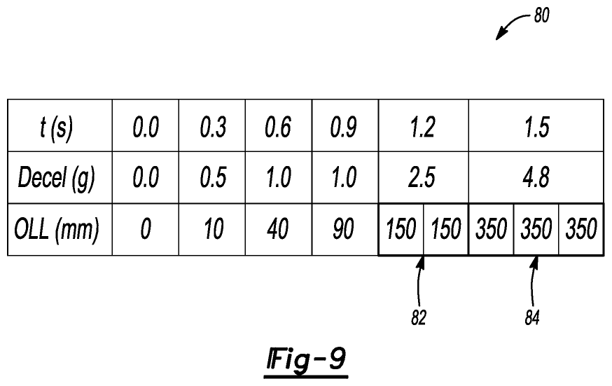

Referring briefly to table 80 of FIG. 9, a sample time window is shown as time (t) in seconds (s), i.e., t(s), for exemplary non-limiting time points. Vehicle deceleration (g) is also depicted with representative values of 0.0 g, 0.5 g, 1.0 g, 2.5 g, and 4.8 g for illustrative simplicity. For each corresponding sample, an occupant landmark location (“OLL”) is shown in millimeters (mm), likewise with representative values of 0 mm, 10 mm, 40 mm, 90 mm, 150 mm, and 350 mm. The actual values may differ with the event, the configuration of the motor vehicle 10, and driving conditions, with the sample time window duration being a calibratable duration that could differ from the example values of FIG. 9. As noted above, the controller 50 may selectively increase the number of data points based on vehicle deceleration. Region 82, for example, shows two data points of 150 mm for the sample at time 1.2 s when the deceleration is between 1.5 g and 3.0 g. Region 84 at time 1.5 s uses three data points of 350 mm when the deceleration exceeds 3.0 g. Thus, the controller 50 may selectively increase the number of data points based on vehicle deceleration in a possible implementation, at least doubling the prior number of samples in some approaches.

Referring now to FIG. 8, the method 100 in a representative embodiment is executed by the controller 50 using the processor 52 of FIG. 3, e.g., as an instruction set from tangible, non-transitory elements of the memory 54 to allow the controller 50 to situationally adjust actual restraint capacity settings of the airbag 18A and possibly one or more other permutations of the passenger restraint systems 18 described above. The method 100 may be performed in a range of manners to provide a desired level of control responsiveness across a continuum of restraint capacity settings. The method 100 of FIG. 8 is therefore just one possible implementation of the present teachings.

The method 100 in this exemplary embodiment commences with terminal or logic block B102 (“REC CC_{I}”) after initialization of the controller 50, e.g., a key-on event of the motor vehicle 10 shown in FIG. 1. As used herein, the term “block” refers to programmed logic, computer-readable code, algorithm(s), or subroutine(s) used by the controller 50 to implement the corresponding functions.

At block B102, the controller 50 of FIGS. 1 and 3 receives the electronic input signals (arrow CC_{I} of FIG. 3) from the sensor suite 30 and/or the sensor(s) 40, either wirelessly, over a controller area network (CAN) bus, or over other application-suitable communication paths, with the electronic input signals (arrow CC_{I} of FIG. 3) including the occupant landmark signals (arrow CC_{LM}). To this end, the electronic input signals (arrow CC_{I}) may include occupant position signals from the position sensor 30D of FIG. 3 indicative of the present location of the occupant 11 within the vehicle interior 14. In the context of the present disclosure, the occupant landmark signals (arrow CC_{LM}) are communicated to the controller 50 according to a calibrated sampling interval. As explained above with particular reference to FIGS. 5-7, the sampling interval may be adjusted in real-time in one or more implementations of the method 100 based on a myriad of factors, including but not limited to braking levels, longitudinal acceleration of the motor vehicle 10, etc.

As also described above, the method 100 may include refining trajectory-based deployment decisions of the controller 50 using other data or performance factors, possibly including a belted/unbelted status of the occupant 11. This may include using the ASZ edge 25 for unbelted occupants 11 and the ASZ edge 26 for belted occupants 11 in some implementations. The determination of which ASZ edge 25 or 26 to use for a given occupant 11 is determined at block B102. Likewise, other adjustments may occur in block 102, including adjusting a field-of-view focus of one or more sensors of the sensor suite 30 and/or the sensor(s) 40 in response to the predicted occupant trajectories or the anticipation of an airbag deployment-triggering event based on vehicle deceleration, etc. Adjusting the field-of-view focus enables the controller 50 to focus on the body regions of interest, such as where the occupant 11 is presently located and predicted to be at one or more future points in time. The adjustment may also focus on predetermined “critical” body regions of interest, such as the occupant's head, neck, and chest/torso. The method 100 proceeds to block B104 once the controller 50 has received the electronic input signals (arrow CC_{I}) inclusive of the occupant landmark signals (arrow CC_{LM}).

Block B104 (“T₁₁”) includes predicting a trajectory/multiple occupant trajectories using the occupant landmark signals (arrow CC_{LM} of FIG. 3). Block B104 may be performed using mathematical methods and/or filtering techniques to predict a next point on a straight or curved line describing the trajectory of a given landmark 32, and thus of the corresponding point on the body region of interest of the occupant 11.

As will be appreciated by those skilled in the art, such methods may include but are not limited to: (1) curve fitting methods, when there is no direct assumption about the noise and motion process, such as linear, polynomial, conic, geometric, etc., using various methods e.g., least square error, absolute error, etc.; (2) adaptive filtering methods or other predictive techniques for signal processing, such as but not limited to adaptive Wiener filtering, Kalman filtering, etc., which may include information or assumption about the noise distribution and/or process or motion equations; (3) artificial intelligence/machine learning methods in which a model/neural network is trained using a set of inputs and outputs, where the inputs consist of previous values of the occupant/landmark positions, and may also include environment values (vehicle kinematics, etc.) and the output is the current position(s) of the occupant/occupant landmarks. The controller 50 could determine the predicted trajectories of the occupant 11 at future time steps.

The method 100 may include extrapolating the occupant trajectories from a time of a last sampling to a time of a next sampling, i.e., t−1 and t+1, respectively, a time of a potential contact of the occupant 11 with the airbag 18A, e.g., an inflated cushion thereof if the airbag 18A was deployed before the next data sample, or a point in time between the time of the potential occupant contact with the airbag 18A and the time of the next sampling. Trajectories may also be extrapolated to predict occupant locations for future sample timeframes in a defined continuum of time. Trajectory predictions may continue to occur, and restraint capacity settings may continue to be adjusted, if the predicted occupant trajectory will be within the limits of the ASZ(s) currently, prior to contact with the airbag 18A, and at contact with the airbag 18A if the airbag 18A were to be deployed. The controller 50 could employ a moving window throughout time to determine a suitable curve fit equation for the occupant landmarks 32. The method 100 then proceeds to block B106.

The above-noted exemplary statistical techniques are appreciated and understood by those skilled in the art, and therefore may be extended to the present task of predicting occupant trajectories within the vehicle interior 14. As an illustrative working example, one may apply (linear) adaptive filtering techniques to assess curve fit to past trajectory locations, performed for each time step:

$${X}_{k} = [ {x}_{1 k} , {x}_{2 k} , … , {x}_{n k} ]$$

$${W}_{k} = [ {w}_{1 k} , {w}_{2 k} , … , {w}_{n k} ]$$

$${y}_{k} = {W}_{k}^{T} {X}_{k}$$

where Xₖ is the measured position of the occupant 11 and contains noise, Wₖ are the filter coefficients or weights, and yₖ is the estimated occupant location at time T, with yₖ=Σᵢxᵢₖwᵢₖ.

With dₖ being the actual occupant location, the error (eₖ) may be defined as:

$$e k = {d}_{k} - {y}_{k} = {d}_{k} - {W}_{k}^{T} {X}_{k}$$

$${e}_{k}^{2} = {d}_{k}^{2} + {W}_{k}^{T} {X}_{k} {X}_{k}^{T} {W}_{k} - 2 {d}_{k} {W}_{k}^{T} {X}_{k}$$

With R being the mean of the error squared, if R=∈[eₖ²] and P=∈[dₖXₖ] where ∈ is the mean operator, the mean square error (MSE) may be calculated as follows:

$${e}^{2} = ∈ [ {e}_{k}^{2} ] = ∈ [ {d}_{k}^{2} ] + {W}^{T} R W - 2 {P}^{T} W$$

Differentiating with respect to W:

$$D = \frac{d ( {e}^{2} )}{d ( W )} = 2 R W - 2 P$$

The minimum is found for D=0:

$$W = {R}^{- 1} P$$

Approximation methods could also be used, e.g., gradient descent and least mean square, recursive mean square, etc. The particular approach selected and implemented by the controller 50 may vary with the intended application and accuracy requirements. For instance, the controller 50 could use a higher-order polynomial to accurately curve fit the trajectories of occupant landmarks for an occupant 11 moving forward or rearward within a moving trajectory evaluation window duration. Or, the controller 50 could perform a least squares fit assessment between the difference of each actual trajectory data point and each curve fit data point for the utilized curve fit equation approaches for the collective set of measured data points within a moving window and select the curve fit approach that offers the lowest least squares value. The lowest least squares value in turn would indicate the most accurate curve fit equation. The equation approach could vary for each occupant landmark being tracked. These or other approaches may be used within the intended scope of the present disclosure.

At block B106 (“T₁₁>CAL?”), the controller 50 determines if the predicted occupant trajectories from block B104 are within a predetermined or calibrated limit. That is, the controller 50 may compare the predicted occupant trajectories, i.e., the trajectories of the various landmarks 32 to the first ASZ edge 25, and possibly the second ASZ edge 26 in embodiments utilizing the second ASZ, and then determine whether the one or more of the predicted occupant/landmark trajectories will result in the landmark(s) 32 moving forward of the ASZ edge 25, currently or within a forward-looking window of time, such as the time necessary to contact the airbag 18A in the event airbag 18A were to be deployed before the next sample.

As an example, the controller 50 could determine that a landmark 32 corresponding to exemplary point P1 of FIG. 4, while still located rearward of the first ASZ edge 25, is presently moving toward the first ASZ edge 25 and will soon move forward of it. The method 100 proceeds to block B108 when one or more of the predicted trajectories will move forward of the first ASZ edge 25 (or the second ASZ edge 26) if left unchanged. The method 100 proceeds in the alternative to block B110 when the predicted trajectories will not be forward of the first ASZ edge 25 (or the second ASZ edge 26) within the representative window of time. It is also possible that the method 100 proceeds to block B108 when the current location of the landmark 32 of the occupant 11 is forward of the first or second ASZ edges 25 or 26.

Block B108 (“CA #1”) of the method 100 includes executing a first control action via the controller 50 in response to the suppressing one or more of the airbags 18A in associated restraint activation logic of the controller 50. For example, the controller 50 may temporarily suppress the airbag 18A located in the predicted path of the occupant 11 in restraint activation logic of the controller 50 before and possibly during the course of a triggering event. Block B108 in one or more embodiments may include processing additional evaluation criteria to further refine the restraint capacity setting adjustments and ASZ locations.

In block B108, the controller 50 may also look at the impact severity, object closing speed relative to the motor vehicle 10 of FIG. 1, or both when determining if the airbags 18A such be suppressed. An unsuppressed restraint state of the airbag(s) 18A or a higher restraint state of the airbag(s) 18A may be established in the restraint activation logic of the controller 50 when the impact severity or the object closing speed is above a corresponding threshold value regardless of whether the occupant 11 has a certain body region within the ASZ edge 25, 26. The controller 50 could also look to the above-described optional occupant classes when determining how to adjust the restraint capacity settings of one or more of the airbags 18A. To that end, an unsuppressed restraint state of each controlled airbag 18A or a higher restraint state of the airbag(s) 18A may be established in the logic of the controller 50 when the occupant class of the measured range is above a predetermined threshold, or when the occupant 11 is verified as being within or matching a predetermined occupant class regardless of whether the occupant 11 has a certain body region within the particular first or second ASZ edge 25 or 26. The method 100 then returns to block 102.

Regarding the occupant movement event, such an event may result in the suppression of the airbag 18A when a portion of a head, neck, torso, and possibly feet of the occupant 11 are predicted to be within a predetermined distance of the airbag 18A, such as within the first or second ASZ edge 25 or 26, as the occupant 11 moves within the vehicle interior 14. Deployment of the airbag 18A may be enabled when the occupant 11 braces against the instrument panel 21 with one or more arms while the head, neck, and torso remain rearward of the ASZ edge 25 or 26. As another option, the airbag 18A may be suppressed if one or both arms of the occupant 11 are forward of the relevant first or second ASZ edge 25 or 26 depending on the implementation.

B110 (“CA #2”) may include controlling the corresponding restraint capacity settings of the various passenger restraint systems 18 in the typical manner. That is, execution of block B110 by the controller 50 occurs when the various landmarks 32 on various regions of interest of the occupant's body do not have corresponding predicted trajectories that would result in movement of the occupant's body forward of the ASZ edge 25, 26 or forward of other defined ASZs. Exemplary control actions performed in block B110 could include adjustments to restraint capacity settings based on the other criteria described above, including but not limited to modifying restraint capacity settings for one or more of the restraint systems 18 of FIG. 3, etc. However, such adjustments could occur separately from the trajectory-based airbag suppression adjustments implemented in block B108.

Block B110 in one or more embodiments may include processing additional evaluation criteria to further refine the restraint capacity setting adjustments and ASZ locations. For example, the controller 50, in addition to position, trajectories, and possible seatbelt usage status of the occupant 11, could look to the above-described optional occupant classes when determining how or when to adjust the restraint capacity settings, of one or more of the airbags 18A. To that end, an unsuppressed restraint state of each controlled airbag 18A or a higher restraint state of the airbag(s) 18A may be established in the logic of the controller 50 when the occupant class of the measured range is above a predetermined threshold or when the occupant 11 is verified as being within or matching a predetermined occupant class.

Likewise, a reduced restraint state of the airbag 18A or a suppressed state of the airbag 18A may be established in the restraint activation logic of the controller 50 when the occupant class of a measured range is below a predetermined threshold or when occupant 11 is verified as being within or matching a predetermined occupant class even if the occupant 11 has a certain body region outside the ASZ edge 25, 26. Automatically adjusting the restraint capacity settings may include adjusting, e.g., a restraint system deployment command decision of the controller 50, an inflator output of the inflator 380 of FIG. 3, timing of the inflator output, an inflated cushion depth of the airbag 18A, an airbag vent size (i.e., a size of the vents 480), etc.

When restraint capacity modification below a full inflation force of at least one of the airbags 18A is called for in an optional two-stage embodiment of the airbag 18A, the controller 50 of FIGS. 1 and 3 could activate logic for a lower total inflation force, e.g., about 70% of a total possible inflation force. The method 100 then proceeds to block B110.

For block B108 or B110, other control responses could be enacted for different restraint systems 18, including possibly adjusting a setting of the pretensioner 180 and/or energy-absorbing device 280 shown in FIG. 3, possibly including the vehicle seat(s) 20 and head restraint(s) 22. An alternative additional approach for blocks B106, B108 and B110 is to continue to predict occupant trajectory after airbag deployment. If it is determined that the occupant is moving within ASZ edge 25, 26, then reduce the restraint capacity of the already deploying airbag by reducing the inflator output for a dual level inflator, adjusting the tether length, or adjusting airbag venting.

As will be appreciated by those skilled in the art, the above teachings enable occupant-specific levels of control to be applied to inflation of one or more airbags 18A shown in FIG. 1. Unlike systems that selectively disable certain restraint devices such as front airbags 18A based on static weight thresholds, the present approach instead provides a level of dynamic refinement by assessing position and predicted trajectory of the various occupants 11 of the vehicle interior 14 of FIG. 1, and by thereafter controlling restraint capacity settings along a permissible continuum. While such capacity adjustments are primarily directed herein to inflation of the airbag 18A and adjustment of locations of one or more ASZs, the method 100 may be fine-tuned to include adjustment of one or more other restraint systems 18 as noted above.

Other possible refinements may be included within the scope of the disclosure, including but not limited to consideration of “occupant type”, i.e., whether the occupant 11 is non-human. Animals and objects, e.g., cargo, packages, luggage, etc., are examples of non-human occupants 11 within the scope of the disclosure. The controller 50 may be calibrated in one or more configurations to assess occupant type and respond accordingly when adjusting restraint capacities. In one or more embodiments, the controller 50 of FIGS. 1 and 3 may suppress the airbag 18A when an animal or object is detected without the presence of a human. The change in location of one or more ASZs in accordance with the present teachings therefore tailors deployment of the airbags 18A to account for the usage of a given one of the seatbelts 18A.

Additionally, the above-described strategy may be expanded to include transmitting, broadcasting, or otherwise providing an “ASZ intrusion” alert message or a series of alert messages to one or more predetermined message recipients, e.g., the occupant(s) 11, a ride share home office, a software application (“app”), etc. Such alert messages could be used to alert recipients that the occupant 11 was detected within the ASZ(s). For the occupant 11 or message recipients located inside of the vehicle interior 14, the alert message may be audible, visual, and/or haptic, and may be initiated by the controller 50 in quasi-static conditions, such as when the occupant 11 leans forward to access something or places their feet or leg(s) on the instrument panel 21. In one or more embodiments, the position of the occupant 11 could be recorded in memory of the controller 50, or in an “outside-the-vehicle” app so that the position/ASZ intrusion data is retrievable after a vehicle event resulting in deployment of the airbag(s) 18A, e.g., by emergency personnel, first responders, investigators, or other interested parties. These and other attendant benefits will be readily appreciated by those skilled in the art in view of the foregoing disclosure. These and other attendant benefits will be readily appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for controlling an airbag aboard a motor vehicle, comprising:
measuring, using a sensor suite of the motor vehicle, a respective position of one or more landmark points located on a body region of interest of an occupant of the motor vehicle;
receiving, via a controller of the motor vehicle at a sampling rate, occupant landmark signals from the sensor suite, wherein the occupant landmark signals include data points indicative of the respective position of the one or more landmark points;
determining a predicted trajectory of the occupant, via the controller, using the occupant landmark signals; and
automatically adjusting a restraint capacity setting of the airbag, via the controller, in response to the predicted trajectory of the occupant.

2. The method of claim 1, further comprising:
detecting, via the sensor suite, at least one of a dynamic vehicle event, an oncoming object size, an oncoming object closing velocity, or an occupant movement event; and
in response to at least one of the dynamic vehicle event, the oncoming object size, the oncoming object closing velocity, or the occupant movement event, selectively increasing or decreasing a sampling rate of the controller during a sampling timeframe of interest.

3. The method of claim 1, further comprising:
detecting, via the sensor suite, at least one of a dynamic vehicle event, an oncoming object size, an oncoming object closing velocity, or an occupant movement event; and
in response to at least one of the dynamic vehicle event, the oncoming object size, the oncoming object closing velocity, or the occupant movement event, selectively increasing a number of the data points to thereby increase the corresponding weight of the data points.

4. The method of claim 1, further comprising:
detecting an occupant movement event via the sensor suite; and
executing a control action aboard the motor vehicle in response to the occupant movement event, wherein the occupant movement event includes actual or predicted movement of at least a portion of the body region of interest of the occupant into an airbag suppression zone (ASZ) of the airbag.

5. The method of claim 4, wherein the control action includes providing an alert message to one or more message recipients in response to the occupant movement event.

6. The method of claim 1, wherein determining the predicted trajectory of the occupant includes extrapolating the predicted trajectory of the occupant from a time of a last sampling to at least one of:
a time of a potential contact by the occupant with the airbag;
a time of a next sampling; or
a point in time between the time of the potential occupant contact with the airbag and the time of the next sampling.

7. The method of claim 1, wherein determining the predicted trajectory of the occupant includes using one or more mathematical curve fitting methods for the position of the occupant using a fixed window or a moving window.

8. The method of claim 1, wherein determining the predicted trajectory of the occupant includes using one or more predictive filtering techniques for signal processing.

9. The method of claim 1, wherein determining the predicted trajectory of the occupant includes using an artificial intelligence or machine learning method.

10. The method of claim 1, wherein the motor vehicle includes a seatbelt, the method further comprising:
using a seatbelt usage status signal indicative of a usage of the seatbelt by the occupant to determine the location of an airbag suppression zone (ASZ) or adjust the restraint capacity setting of the airbag.

11. The method of claim 1, wherein receiving the occupant landmark signals, determining the predicted trajectory of the occupant, and automatically adjusting the restraint capacity setting of the airbag are performed by the controller prior to and subsequent to an airbag deployment command decision of the controller.

12. The method of claim 11, wherein determining the predicted trajectory of the occupant includes, subsequent to a deployment of the airbag in response to the deployment command decision, adjusting the restraint capacity setting when the predicted trajectory of the occupant will be within an airbag deployment zone (ASZ) when the occupant contacts the airbag.

13. The method of claim 1, wherein at least one sensor of the sensor suite has a field-of-view focus, the method further comprising:
adjusting the field-of-view focus, via the controller, in response to at least one of the predicted trajectory, a dynamic vehicle event, an oncoming object, or an occupant movement event.

14. The method of claim 1, wherein automatically adjusting the restraint capacity setting includes adjusting one or more of a deployment command decision of the controller, an inflator output, timing of an inflator output, a tether length of the airbag, an inflated cushion depth of the airbag, and a vent size of the airbag.

15. The method of claim 1, further comprising:
tracking a trajectory of a most forward point on the body region of interest of the occupant, wherein the most forward point is predicted to be forward of an edge of an airbag suppression zone (ASZ); and
adjusting the restraint capacity setting by suppressing the airbag in response to the trajectory of the most forward point when the most forward point is a point on a head, a neck, a torso, or a leg of the occupant.

16. The method of claim 1, wherein the motor vehicle includes an instrument panel, and wherein automatically adjusting the restraint capacity setting of the airbag includes suppressing the airbag when a leg of the occupant is placed on the instrument panel.

17. The method of claim 1, further comprising:
determining a seated height of the occupant relative to the vehicle interior;
automatically selecting at least one of the one or more landmark points, via the controller, based on the seated height of the occupant, as selected landmark points; and
determining the predicted trajectory of the occupant using the selected landmark points.

18. A motor vehicle comprising:
a vehicle body defining a vehicle interior;
an airbag positioned in the vehicle interior, the airbag having an airbag suppression zone (ASZ);
a sensor suite positioned in the vehicle interior and configured to measure respective positions of one or more landmark points on a body region of interest of an occupant of the vehicle interior relative to a position of the airbag; and
a controller operable for controlling a restraint capacity setting of the airbag, wherein the controller is programmed to:
receive occupant landmark signals from a sensor suite, wherein the occupant landmark signals are indicative of the respective locations of the one or more landmark points;
determine a predicted trajectory of the occupant using the occupant landmark signals;
automatically adjust a restraint capacity setting of the airbag in response to the predicted trajectory of the occupant.

19. The motor vehicle of claim 18, wherein the one or more landmark points includes a landmark point located closest to the airbag relative to each of the one or more landmark points.

20. A non-transitory computer-readable storage medium on which is recorded an instruction set, wherein an execution of the instruction set by a processor of a controller of a motor vehicle having an airbag causes the controller to:
receive occupant landmark signals from a sensor suite, wherein the occupant landmark signals are indicative of at least one landmark point on a body region of interest of an occupant of the motor vehicle;
determine a predicted trajectory of the occupant via the controller using the occupant landmark signals;
automatically adjust a restraint capacity setting of the airbag via the controller in response to the predicted trajectory of the occupant.
